(19) United States
(12) Patent Application Publication
(10) Pub. No.: US 2022/0404802 A1
(43) Pub. Date: Dec. 22, 2022

(54) Cutting Machine Comprising a Force Transducer, Process of Operating Such Cutting Machine and Process of Calibrating the Force Transducer of Such a Cutting Machine

(71) Applicant: KISTLER HOLDING AG, Winterthur (CH)

(72) Inventors: Tobias Fimpel, Ermatingen (CH); Gunnar Keitzel, Hettlingen (DE)

(21) Appl. No.: 17/772,706

(22) PCT Filed: Oct. 16, 2020
(86) PCT No.: PCT/EP2020/079234

§ 371 Date: Apr. 28, 2022

(30) Foreign Application Priority Data
Nov. 12, 2019 (EP) 19208608.0

(51) Int. Cl. G05B 19/4155; B23Q 15/12

(52) U.S. Cl. CPC G05B 19/4155; B23Q 15/12; G05B 2219/37355

(57) ABSTRACT

A cutting machine includes a tool holder for holding the tools required for chip-removing machining of a workpiece, and a tool arm connecting the tool holder to a drive unit, which moves the tool arm to align one of the required tools with a workpiece in each manufacturing step. The tool arm includes an upper arm connected with the drive unit and mechanically connected to a lower arm. The lower arm is connected with the tool holder. At least one force transducer is positioned between the upper arm and the lower arm so that during chip-removing machining of a workpiece, the force transducer is capable of measuring a tool force exerted by any of the required tools in a main flow of forces.

### CROSS REFERENCE TO RELATED APPLICATIONS

The present application claims priority to International Application Serial No. PCT/EP2020/0679234, which is hereby incorporated herein in its entirety by this reference for all purposes.

### FIELD OF THE INVENTION

The present invention relates to a cutting machine that includes a force transducer disposed between upper and lower arms of a tool arm. Furthermore, the invention relates to a process for operating such a cutting machine. Moreover, the invention relates to a process for calibrating the force transducer of such a cutting machine.

### BACKGROUND OF THE INVENTION

Cutting machines are well known. Known cutting machines include lathes, milling machines, machine saws, etc. Cutting machines are used to shape a workpiece by chip-removing machining, i.e. by removing material from the workpiece by means of a wedge-shaped cutting blade. The cutting blade exerts a tool force. The workpiece is made of any material such as metal, wood, plastics, etc. The cutting blade is made of a hard, resistant and tough cutting material such as metal, ceramics, etc. Known tools used for chip-removing machining are chisels, turning chisels, milling cutters, counterbores, saw blades, etc.

For chip-removing machining the workpiece and tool are moved relative to each other. To this end, both the workpiece and the tool are moved in a straight line or in a circle. The cutting machine comprises several drive units such as electrical drive units, pneumatic drive units, etc. for this purpose.

The tool force as well as the elevated temperatures that occur during chip-removing machining may lead to abrasion of the cutting blade so that it is desirable to measure the tool force for cost-effective production of a workpiece with consistent quality. Abrasion alters the blade geometry of the cutting blade. In addition, a cutting blade subject to abrasion requires a greater tool force for chip-removing machining of the workpiece which is reflected in a higher energy consumption of the cutting machine and which also reduces the surface quality and dimensional accuracy of the workpiece.

Applicant's commonly owned EP0433535A1 discloses an arrangement comprising a multi-component force transducer for measuring the tool force during chip-removing machining of a workpiece in a cutting machine. The multi-component force transducer is inserted in a recess of a machine portion by means of a frictional connection.

However, the arrangement of EP0433535A1A has the disadvantage that the tool force is not measured at its point of action, i.e. at the cutting blade, but at a point remote from the cutting blade, namely in a machine portion. Moreover, there the tool force is measured in an indirect manner as a mechanical stress occurring in the machine portion. The mechanical stress is in turn affected by the dimensions and mass of the machine portion. In addition, the multi-component force transducer is arranged in a force shunt in the machine portion. Only a small fraction of the mechanical stress that occurs can be measured in a force shunt. Together, this leads to the tool force being measured with poor accuracy. An accuracy when measuring the tool force is an indication of a difference between the measured tool force and the actual tool force; the more accurate the measurement of the tool force is the smaller will be the difference between the measured tool force and the actual tool force.

Chip-removing machining of a workpiece is normally performed in a chronological sequence of manufacturing steps by using a plurality of required tools. Thus, the tool is changed frequently. In each new manufacturing step a new tool is aligned with the workpiece and tool and workpiece are moved relative to one another. For this purpose, the cutting machine comprises a tool holder for changing the tool quickly and inexpensively and also for achieving tool alignment in a quick and inexpensive manner. The tool holder holds the tools required for each of the manufacturing steps. The tool holder is moved when a new tool is required and the new tool must be aligned with the workpiece. The tool holder is attached to a tool arm for this purpose. Thus, it is the tool arm that is moved by a drive unit for aligning a tool in the tool holder and required for a particular manufacturing step with the workpiece and for moving the tool and the workpiece relative to one another.

### EXEMPLARY OBJECT AND SUMMARY OF THE INVENTION

It is a first object of the present invention to measure the tool force that acts during chip-removing machining of a workpiece in a cutting machine with high accuracy by means of a force transducer. In particular, this object shall be achieved for a cutting machine comprising a tool holder which is moved by a drive unit via a tool arm. A second object of the invention is to provide a space-saving solution for the arrangement of a force transducer used for measuring the tool force during chip-removing machining of a workpiece in the cutting machine. In addition, a third object of the invention is to measure the tool force that acts during chip-removing machining of a workpiece by means of a force transducer in a cost-effective manner.

At least one of these objects has been achieved by the features described more fully below.

The invention relates to a cutting machine for chip-removing machining of a workpiece, said chip-removing machining being carried out in a chronological sequence of manufacturing steps by means of a plurality of required tools; comprising a tool holder for holding said required tools; comprising a tool arm for connecting the tool holder to a drive unit; wherein said drive unit moves the tool arm, which movement of the tool arm aligns one of the required tools with a workpiece in each manufacturing step, said tool arm comprising an upper arm and a lower arm, said upper and lower arms being separate units and mechanically connected to one another; wherein said upper arm is connected with the drive unit; wherein said lower arm is connected with the tool holder; and wherein at least one force transducer is arranged in a position between said upper arm and said lower arm, wherein during chip-removing machining of a workpiece said force transducer is capable of measuring a tool force exerted by any of the required tools in the main flow of forces.

The present invention is based on the observation that for precise alignment of the required tools with the workpiece and for precisely moving the required tools relative to the workpiece, the required tools are held by the tool holder in an inelastic manner and the tool holder is connected to the tool arm in an inelastic manner. Now, the present inventors have found that the inelastic mechanical connections of the required tools to the tool holder and further to the tool arm also enable a substantially undamped flow of forces of the tool force from any of the required tools into the tool arm. The reason for this is that each elastic deformation dampens the flow of forces of the tool force, thus falsifying the measurement of the tool force. It will be appreciated that by arranging the force transducer in the main flow of forces in a position between an upper arm and a lower arm, it will be possible to eliminate elastic deformation occurring before the tool force reaches the measuring sensor and accordingly measure the tool force accurately. The force transducer is positioned inside a two-piece tool arm thus saving space and furthermore being cost-effective since in this way the predefined external dimensions of a conventional tool arm may be maintained and it will not be necessary to modify a conventional cutting machine. The only difference is that the conventional tool arm is replaced by a tool arm according to the invention.

Further advantageous solutions of the object have been achieved by the features described below.

### BRIEF DESCRIPTION OF THE DRAWINGS

In the following, the invention will be described by way of example with reference to the drawings in which

FIG. 1 shows a schematic view of portions of a first embodiment of a cutting machine having one force transducer;

FIG. 2 shows an exploded view of portions of a second embodiment of a cutting machine having two force transducers;

FIG. 3 shows a flow chart depicting process steps for calibrating the at least one force transducer of the cutting machine according to FIG. 1 or 2; and

FIG. 4 shows a schematic view of portions of an embodiment of a calibrating device for carrying out the process steps according to FIG. 3 with the second embodiment of the cutting machine that comprises two force transducers according to FIG. 2.

Throughout the drawings, the same parts are designated by the same reference numerals.

### DETAILED DESCRIPTION OF EXEMPLARY EMBODIMENTS OF THE INVENTION

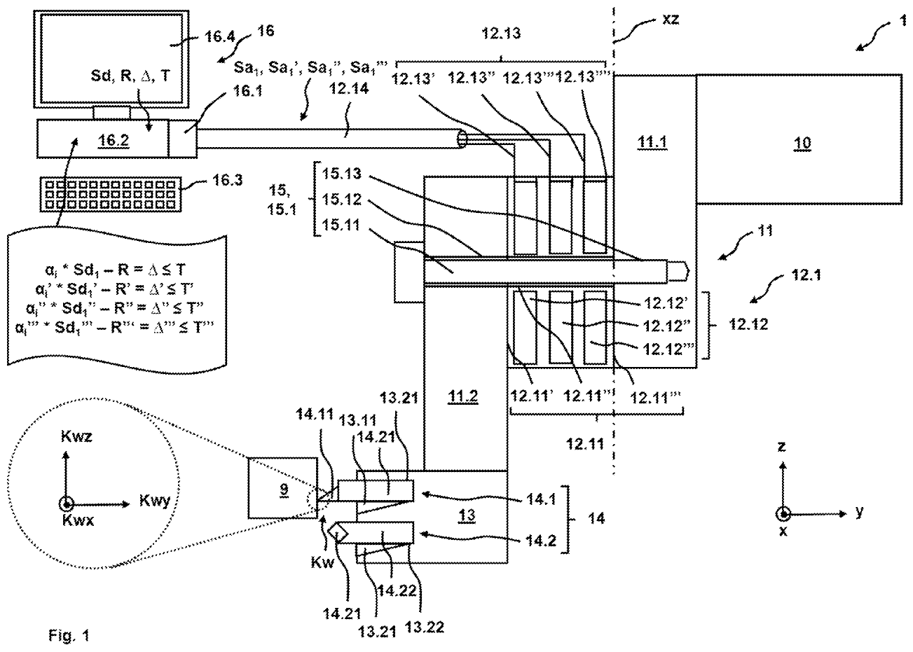

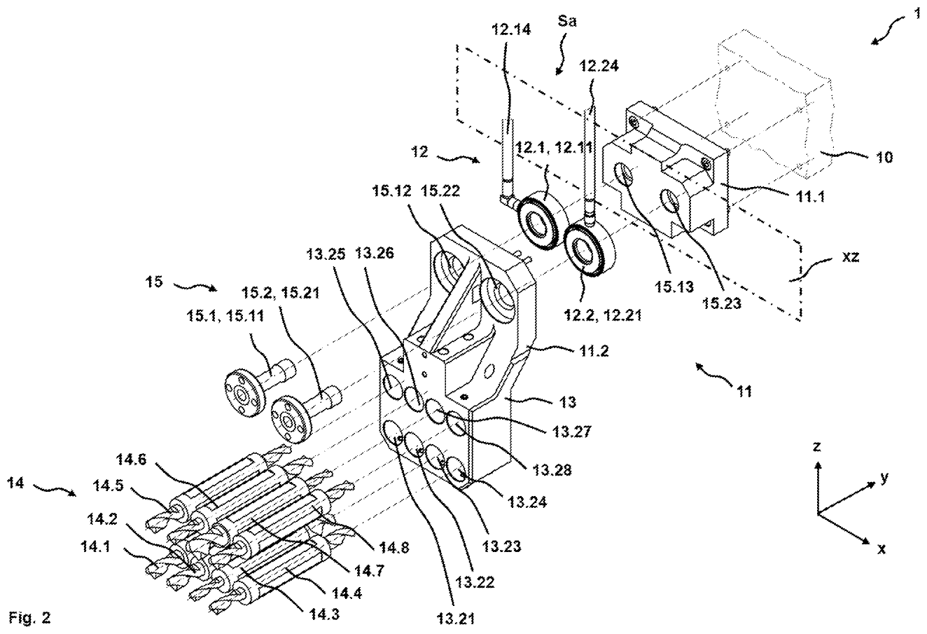

FIGS. 1 and 2 show portions of two embodiments of a cutting machine 1 for chip-removing machining of a workpiece 9. Cutting machine 1 comprises a drive unit 10, a machine tool arm 11, at least one force transducer 12.1, 12.2, a tool holder 13 and a plurality of required tools 14. The cutting machine 1 is arranged in an orthogonal coordinate system with three axes, x, y, z, wherein the three axes are also referred to as the transverse axis x, horizontal axis y and vertical axis z.

The workpiece 9 consists of any material such as metal, wood, plastics, etc. The chip-removing machining of the workpiece 9 is carried out in a chronological sequence of manufacturing steps by using a plurality of required tools 14. In the first embodiment of the cutting machine 1 according to FIG. 1, two tools 14.1, 14.2 are required in two manufacturing steps. A first tool 14.1 is required in a first manufacturing step and a second tool 14.2 is required in a second manufacturing step. However, those skilled in the art may of course use the invention for chip-removing machining of a workpiece by more than two tools. For example, in the second embodiment of the cutting machine 1 according to FIG. 2, eight tools 14.1-14.8 are required in eight manufacturing steps.

During chip-removing machining of the workpiece 9 the required tools 14 perform a cutting motion in a transverse plane xy defined by the transverse axis x and the vertical axis z. Furthermore, during chip-removing machining of the workpiece 9 the required tools 14 perform an advancing movement along the horizontal axis y. In this manner, the required tools 14 exert a tool force Kw onto the workpiece 9. The tool force Kw comprises three force components, Kwx, Kwy, Kwz. Because of the cutting movement the tool force Kw comprises a transverse shear component, Kwx, in the direction of the transverse axis x and a vertical shear component, Kwz, in the direction of the vertical axis z. In addition, due to the advancing movement the tool force Kw comprises a horizontal force component, Kwy, in the direction of the horizontal axis y.

The tool holder 13 holds the tools 14 required for the manufacturing steps. Tool holder 13 is made of mechanically resistant material such as steel, tool steel, etc. In the first embodiment of the cutting machine 1 according to FIG. 1, the tool holder 13 holds two required tools 14.1, 14.2. In the second embodiment of the cutting machine 1 according to FIG. 2, the tool holder 13 holds eight required tools 14.1-14.8.

As shown for the first embodiment of the cutting machine 1 according to FIG. 1, each required tool 14.1, 14.2 comprises at least one cutting blade 14.11, 14.12 and a shank 14.21, 14.22. The cutting blade 14.11, 14.12 is made of a hard, resistant and tough cutting material such as metal, ceramics, etc. A first required tool 14.1 comprises a triangular cutting blade 14.11 and a second required tool 14.2 comprises a rectangular cutting blade 14.21. In the second embodiment of the cutting machine 1 according to FIG. 2, each required tool 14.1-14.8 comprises two cutting blades and a shank where the cutting blades are located at opposite ends of the shank.

Tool holder 13 is made of a material having a high modulus of elasticity of more than 200 GPa which is different from that of a conventional cast iron tool holder having a usual modulus of elasticity of 110 GPa. The tool holder 13, due to its high modulus of elasticity, transmits the tool force Kw by a factor of two more inelastically as compared to the conventional tool holder.

The required tools 14 are held in the tool holder 13 via their shank. For this purpose, tool holder 13 comprises a plurality of holding means and a plurality of recesses.

In the first embodiment of the cutting machine 1 according to FIG. 1, a first recess 13.21 receives the first shank 14.21 and a first holding means 13.11. A second recess 13.22 accommodates the second shank 14.22 and a second holding means 13.12. The first and second holding means 13.11, 13.12 are wedge-shaped and hold the shank 14.21, 14.22 in the recess 13.21, 13.22 on the basis of the mechanical principle of the inclined plane with a certain holding force. The first recess 13.21 and second recess 13.22 are arranged one above the other with respect to the vertical axis z.

In the second embodiment of the cutting machine 1 according to FIG. 2, eight recesses 13.21-13.28 each accommodate a shank of one of the eight required tools 14.1-14.8 as well as a holding means. The holding means are grub screws and project into the recesses 13.21-13.28 at a right angle with respect to the horizontal axis y. One grub screw each presses against a shank of a required tool 14.1-14.8 and holds the required tool 14.1-14.8 in the recess 13.21-13.28 with a certain holding force.

An amount of the holding force for the required tools 14 within the tool holder 13 is at least one order of magnitude higher than an amount of the tool force Kw so that the tool holder 13 holds the required tools 14 in an inelastic manner. In the context of the present invention, the adjective “inelastic” means that regardless of the external forces every point of a required tool 14 and every point of the tool holder 13 are always at the same distance from each other.

The tool holder 13 is connected with the tool arm 11. The tool arm 11 is made of mechanically resistant material such as steel, tool steel, etc. The tool arm 11 comprises an upper arm 11.1, a lower arm 11.2 and at least one connecting means 15. The tool holder 13 is connected with the lower arm 11.2. The drive unit 10 is connected with the upper arm 11.1. The connection may be achieved by any securing means such as a screw connection, a solder connection, a welded connection, etc.

An amount of a securing force of the connection of the tool holder 13 to the lower arm 11.2 and the connection of the drive unit 10 to the upper arm 11.1 is at least one order of magnitude higher than the amount of the tool force Kw so that, in the connected state, the tool holder 13 is secured to the lower arm 11.2 in an inelastic manner and the drive unit 10 is secured to the upper arm 11.1 in an inelastic manner.

The tool arm 11 is made of material having a high modulus of elasticity of more than 200 GPa which is different from that of a conventional cast iron machine tool arm having a usual modulus of elasticity of 110 GPa. From a technical point of view, a modulus of elasticity that is relatively higher by a factor two makes sense for two reasons:

First, the outer dimensions of the tool arm 11 are predefined. However, since the tool arm 11 is adapted for accommodating the force transducer 12.1, 12.2 in its interior space, the tool arm 11 comprises inner spaces for the force transducer 12.1, 12.2 and, therefore, the tool arm 11 is made of less material. On the other hand, a minimum mechanical stability of the tool arm 11 must be maintained for the precise alignment of the required tools 14 with the workpiece 9 and for precisely moving the required tools 14 relative to the workpiece 9. This minimum mechanical stability of the tool arm 11 is achieved by the high modulus of elasticity of more than 200 GPa. In the context of the present invention, the terms “precise alignment” and “precisely moving” are intended to mean an accuracy of position during alignment and moving along the three axes x, y, z of ±1 μm.

Second, tool arm 11, due to its high modulus of elasticity, transmits the tool force Kw by a factor of two more inelastically than the conventional tool arm.

The upper arm 11.1 and the lower arm 11.2 are separate entities. For the purposes of the present invention, the term “separate entity” means that the upper arm 11.1 and the lower arm 11.2 are objects separate from one another. Preferably, the upper arm 11.1 and the lower arm 11.2 are mechanically connected to one another in the transverse plane xz. The upper arm 11.1 and the lower arm 11.2 are mechanically connected to one another by the connecting means 15.

In the first embodiment of the cutting machine 1 according to FIG. 1, the connecting means 15 is a first connecting means 15.1. The first connecting means 15.1 is a screw connection consisting of a screw 15.11, a bore 15.12 in the lower arm 11.2 and an internal thread 15.13 in the upper arm 11.1. The screw connection is made parallel to the horizontal axis y. An external thread of the screw 15.11 extends through the bore 15.12 and the internal thread 15.13. Upon screwing the external thread into the internal thread 15.13 a screw head of the screw 15.11 presses the lower arm 11.2 against the upper arm 11.1.

In the second embodiment of the cutting machine 1 according to FIG. 2, the connecting means 15 comprises two connecting means 15.1, 15.2. A first connecting means 15.1 is a screw connection comprising a screw 15.11, a bore 15.12 in the lower arm 11.2 and an internal thread 15.13 in the upper arm 11.1. A second connecting means 15.2 is a screw connection comprising a screw 15.21, a bore 15.22 in the lower arm 11.2 and an internal thread 15.23 in the upper arm 11.1. The two connecting means 15.1, 15.2 are arranged in parallel to each other in a horizontal plane xy defined by the transverse axis x and the horizontal axis y. The two screw connections are parallel to the horizontal axis x. An external thread of the screw 15.11, 15.21 extends through the bore 15.12, 15.22 and the internal thread 15.13, 15.23. Upon screwing the external thread into the internal thread 15.13, 15.23, a screw head of the screw 15.11, 15.21 presses the lower arm 11.2 against the upper arm 11.1.

An amount of a connecting force of the mechanical connection between the upper arm 11.1 and lower arm 11.2 by means of the connecting means 15 is at least one order of magnitude higher than the amount of the tool force, Kw, so that the upper arm 11.1 is mechanically connected to the lower arm 11.2 in an inelastic manner. However, instead of a screw connection those skilled in the art and knowing the present invention may of course employ a soldered connection, a welded connection, etc.

The drive unit 10 is an electrical drive unit, a pneumatic drive unit, etc. The drive unit 10 moves the machine tool arm 11 along the three axes x, y and z. However, the skilled artisan may of course use the invention with more than one drive unit.

In the first embodiment according to FIG. 1, the cutting machine 1 comprises a force transducer 12.1. In the second embodiment according to FIG. 2, the cutting machine 1 comprises two force transducers 12.1, 12.2. The at least one force transducer 12.1, 12.2 is arranged in a position between the upper arm 11.1 and the lower arm 11.2 in the plane of the connection 11.3. However, those skilled in the art knowing the present invention are free to decide how many force transducers shall be positioned between the upper arm and the lower arm. The use of a single force transducer is completely sufficient for measuring the tool force. The use of two force transducers allows the measurement of the tool force to be redundant; the two force transducers measure the tool force independently of one another and they generate measurement signals for the measured tool force independently of one another and an arithmetic mean can be calculated from these measurement signals so that this way of measuring of the tool force is statistically more accurate than that carried out with a single force transducer.

In the first embodiment of the cutting machine 1 according to FIG. 1, a force transducer 12.1 comprises a housing 12.11 made of mechanically resistant material such as steel, tool steel, etc. In the second embodiment of the cutting machine 1 according to FIG. 2, a first force transducer 12.1 comprises a first housing 12.11 and a second force transducer 12.2 comprises a second housing 12.21.

In the following, a detailed description of the force transducer 12.1, 12.2 will be given referring to the first embodiment of the cutting machine 1 according to FIG. 1. This detailed description of the force transducer 12.1 also applies to the two force transducers 12.1, 12.2 of the second embodiment of the cutting machine 1 according to FIG. 2.

The force transducer 12.1 is hollow-cylindrical in shape and comprises two housing end faces 12.11′, 12.11″ and a housing bore 12.11″. By a first housing end face 12.11′, the force transducer 12.1 is in surface contact with the lower arm 11.2 and by a second housing end face 12.11′″, the force transducer 12.1 is in surface contact with the upper arm 11.1. The first housing end face 12.11′ is parallel to the transverse plane xz, the second housing end face 12.11′″ is in the transverse plane xz. A longitudinal axis of the housing bore 12.11″ is parallel to the horizontal axis y. A diameter of the housing bore 12.11″ is large enough to allow the screw 15.11 to protrude therethrough.

Via the housing end faces 12.11′, 12.11″ the tool force Kw to be measured acts onto the force transducer 12.1. A surface area of the housing end faces 12.11′, 12.11″ is at least one order of magnitude larger than a cross-sectional area of the screw 15.11. The force transducer 12.1 measures a fraction of the tool force Kw of at least 90%. Thus, force transducer 12.1 is arranged between the upper arm 11.1 and the lower arm 11.2 in the main flow of forces. For this reason, force transducer 12.1 measures the tool force Kw with very high sensitivity. For the purposes of the present invention, the sensitivity is a ratio of the amounts of the analog measurement signals Sa generated by the force transducer 12. under the action of the tool force Kw and of the tool force Kw acting on the force transducer 12.1.

Force transducer 12.1 is a piezoelectric force transducer comprising piezoelectric material 12.12 made of a single crystal such as quartz (SiO₂), calcium gallo-germanate (Ca₃Ga₂Ge₄O₁₄ or CGG), langasite (La₃Ga₅SiO₁₄ or LGS), tourmaline, gallium orthophosphate, etc., and of piezoceramics such as lead zirconate titanate (Pb[ZrₓTi₁₋ₓ]O₃, 0≤≤1), etc.

The piezoelectric material 12.12 has a hollow-cylindrical shape and comprises end faces that are parallel to the housing end faces 12.11′, 12.11′″ and, thus, parallel to the transverse plane xz. In this way, the tool force Kw to be measured acts onto the end faces of the piezoelectric material 12.12. The orientation of the piezoelectric material 12.12 is such that it has maximum sensitivity for the tool force Kw to be measured on those end faces onto which the tool force Kw acts. When it has maximum sensitivity the piezoelectric material 12.12 generates a largest number of electrical polarization charges. To this end, the piezoelectric material 12.12 that consists of a single crystal is cut into hollow cylinders oriented to generate a highest number of electrical polarization charges for a tool force Kw that acts onto the end faces. And the piezoelectric material 12.12 consisting of piezoceramics is polarized in an electric field and formed into a hollow-cylindrical shape by mechanical pressing so that it generates a highest number of electrical polarization charges for a tool force Kw that acts onto the end faces.

Force transducer 12.1 measures the three tool force components, Kwx, Kwy, Kwz, of the tool force Kw. For this purpose, force transducer 12.1 comprises three piezoelectric elements 12.12′, 12.12″, 12.12″ consisting of piezoelectric material 12.12. A first piezoelectric element 12.12′ is oriented to generate electrical polarization charges with maximum sensitivity to the shear force component Kx in the direction of the transverse axis x. In the example, a second piezoelectric element 12.12″ is oriented to generate electrical polarization charges with highest sensitivity for the shear force component Kz in the direction of the vertical axis z. Furthermore, in the example a third piezoelectric element 12.12″ is oriented to generate electrical polarization charges with highest sensitivity for the normal force component Ky in the direction of the horizontal axis y.

The electrical polarization charges must be tapped from the end faces. For this purpose, the force transducer 12.1 comprises electrodes 12.13. The electrodes 12.13 are made of electrically conductive material 12.3 such as copper, gold, etc. and are hollow-cylindrical in shape. One electrode 12.13 each is arranged directly on one of the end faces of the piezo elements 12.12′, 12.12″, 12.12″. Thus, the force transducer 12.1 comprises a total of six electrodes 12.13. Three signal electrodes 12.13′, 12.13″, 12.13′″ receive electrical polarization charges as the analog measurement signals Sa from first end faces, three ground electrodes 12.13″″ receive electrical polarization charges from second end faces. The analog measurement signals Sa are proportional to the amount of the tool force Kw. The three signal electrodes 12.13′, 12.13″, 12.13″ are electrically insulated from the housing 12.11 and the three ground electrodes 12.13″″ are electrically connected to the housing 12.11 and are on the electrical ground potential of the housing 12.11. All of the ground electrodes 12.13″″ are designated by the same reference numeral because all of them are on the same electrical ground potential. The three signal electrodes 12.13′, 12.13″, 12.13′″ are electrically connected to a signal cable 12.14. The signal cable 12.14 transmits the analog measurement signals Sa from the signal electrodes 12.13′, 12.13″, 12.13′″ to an evaluation unit 16.

For each manufacturing step performed with a required tool 14, the force transducer 12.1 generates analog measurement signals Sa₁. The analog measurement signals Sa comprise analog transverse shear signals Sa₁′ for a transverse shear component Kwx in the direction of the transverse axis x, analog vertical shear signals Sa₁″ for a vertical shear component Kwz in the direction of the vertical axis z and analog horizontal force signals Sa₁′″ for a horizontal force component Kwy in the direction of the horizontal axis y. Each manufacturing step takes 1 sec to 100 sec. The force transducer 12.1 generates the analog measurement signals Sa₁ with a temporal resolution in a frequency range from 1 kHz to 50 kHz.

The electrodes 12.13 are mechanically preloaded against the end faces of the piezo elements 12.12′, 12.12″, 12.12′″ so that the electrodes 12.13 pick off all generated electrical polarization charges from the end faces of the piezo elements 12.12′, 12.12″, 12.12″ and no electrical polarization charges remain on the end faces of the piezo elements 12. 12′, 12.12″, 12.12′″ which would falsify the measurement of the tool force Kw. Mechanical preloading of the force transducer 12.1 closes micropores on the interface between the electrodes 12.13 and the end faces of the piezo elements 12.12′, 12.12″, 12.12″. Mechanical preloading of the force transducer 12.1 is provided by the connecting means 15. The connecting means 15.1 consists of the screw connection formed by the screw 15.11 extending through the bore 15.12 in the lower arm 11.2 and through the housing bore 12.11″ in the housing 12.1 with the internal thread 15.13 in the upper arm 11.1. When the external thread is screwed into the internal thread 15.13, the screw head of the screw 15.11 presses the lower arm 11.2 against the upper arm 11.1 and mechanically preloads the electrodes 12.13 against the end faces of the piezo elements 12.12′, 12.12″, 12.12″. Due to the mechanical connection of the upper arm 11.1 to the lower arm 11.2, the connecting means 15 further mechanically preloads the force transducer 12.1. The mechanical preload is equal to the connecting force of the mechanical connection of the upper arm 11.1 to the lower arm 11.2.

The evaluation unit 16 comprises at least one converter unit 16.1, at least one computer 16.2, at least one input unit 16.3 and at least one output unit 16.4.

The force transducer 12.1 is electrically connected to the converter unit 16.2 via the signal cable 12.14. The converter unit 16.1 converts analog measurement signals Sa₁ received from the signal electrodes 12.13′, 12.13″, 12.13″ via the signal cable 12.14 in digital measurement signals Sd₁. For each manufacturing step performed with a required tool 14, the converter unit 16.1 converts analog measurement signals Sa₁ in digital measurement signals Sd₁. The converter unit 16.1 converts analog transverse shear signals Sa₁′ in digital transverse shear signals Sd₁′, it converts analog vertical shear signals Sa₁″ in digital vertical shear signals Sd₁″ and it converts analog horizontal force signals Sa₁′″ in digital horizontal force signals Sd₁′″. The digital measurement signals Sd₁ include the digital transverse shear signals Sd₁″, the digital vertical shear signals Sd₁″ and the digital horizontal force signals Sd₁″.

The computer 16.2 comprises at least one data processor and at least one data memory. The computer 16.2 may be operated by the input unit 16.3. The input unit 16.3 may be a keyboard for inputting control commands. In the context of the present invention, the verb “operate” means that the computer 16.2 is started, controlled and switched off by control commands input by a user via the input unit 16.3. The computer 16.2 loads the digital measurement signals Sd₁. The computer 16.2 displays the loaded digital measurement signals Sd₁ on the output unit 16.4. The output unit 16.4 may be a screen for displaying a graphical representation of the evaluated digital measurement signals.

For evaluation of the digital measurement signals Sd₁, computer 16.2 loads reference signals R and calibration factors αᵢ.

The reference signals R are specific for the material of the workpiece 9 as well as for the cutting material of the required tool 14. Important in this respect are the properties of the material and cutting material such as strength, toughness and hardness. Reference signals R are stored in the data memory of the computer 16.2 for each material of the workpiece 9 and each cutting material of the required tool 14 and may be loaded from the data memory by the computer 16.2. A reference signal R for each required tool 14, comprises a transverse shear reference signal R′, a vertical shear reference signal R″ and a horizontal force reference signal R′″.

Furthermore, the tool force Kw measured by the force transducer 12.1, 12.2 is specific for a position i of the required tool 14 relative to the force transducer 12.1, 12.2. In the second example of an embodiment according to FIG. 2, the tool arm 11 of the cutting machine 1 comprises eight recesses 13.21-13.28 in eight different positions i, i=1 . . . 8, and the cutting machine 1 comprises two force transducers 12.1, 12.2. Each of the eight recesses 13.21-13.28 is located at a different distance from each of the two force transducers 12.1, 12.2. These different distances of each of the recesses 13.21-13.28 to each of the two force transducers 12.1, 12.2 result in each required tool 14 being arranged in a specific position i with respect to the force transducer 12.1, 12.2 whereby also the flow of forces of the tool force Kw is specific for said position i of the required tool 14 with respect to each of the two force transducers 12.1, 12.2.

Therefore, calibration factors αᵢ for each position i are stored in the data memory of the computer 16.2 and may be loaded from the data memory by the computer 16.2. Each calibration factor αᵢ includes a transverse shear calibration factor αᵢ′, a vertical shear calibration factor αᵢ″ and a horizontal shear calibration factor αᵢ″.

Computer 16.2, for performing an evaluation, calibrates digital measurement signals Sd₁ of a required tool 14 by multiplying them with a calibration factor αᵢ of the position i of the required tool 14 relative to the force transducer 12.1, 12.2. For each process step, computer 16.2 calculates a difference Δ of the calibrated digital measurement signals Sd₁ and the loaded reference signal R for the material of the workpiece 9 and the cutting material of the required tool 14.

αᵢ*Sd₁−R=Δ≤T=10%*R

At least one predefined amount of tolerance T is stored in the data memory of the computer 16.2, which predefined tolerance value T is loaded for each manufacturing step. Each predefined tolerance value T comprises a predefined transverse shear tolerance value T′, a predefined vertical shear tolerance value T″ and a predefined horizontal force tolerance value T′″.

The difference Δ is compared to the predefined tolerance value T for each manufacturing step. In the case where the difference Δ is smaller than/equal to the predefined tolerance value T, the required tool 14 is not subject to abrasion and may be continued to use, and with a difference Δ greater than the predefined tolerance value T the required tool (14) is subject to abrasion and will be replaced. As a first approximation, the predefined tolerance value T is equal to 10% of the reference signals R.

The computer 16.2 performs the evaluation also for digital measurement signals Sd₁′, Sd₁″, Sd₁′″ of the tool force components Kwx, Kwy, Kwz of the tool force Kw.

For each process step, the computer 16.2 calculates a transverse shear difference Δ′ of the calibrated digital transverse shear measurement signals Sd₁′ and the loaded transverse shear reference signal R′ for the material of the workpiece 9 and the cutting material of the required tool 14. When the transverse shear difference Δ′ is smaller than/equal to the predefined transverse shear tolerance value T′, the required tool 14 is not subject to abrasion and will be continued to use, and with a transverse shear difference Δ′ that is greater than the predefined transverse shear tolerance value T′, the required tool (14) is subject to abrasion and will be replaced. As a first approximation, the predefined transverse shear tolerance value T′ is equal to 10% of the transverse shear reference signals R′.

αᵢ′*Sd₁′−R′=Δ≤T′=10%*R′

For each process step, the computer 16.2 calculates a vertical shear difference Δ″ of the calibrated digital vertical shear measurement signals Sd₁″ and the loaded vertical shear reference signal R″ for the material of the workpiece 9 and the cutting material of the required tool 14. When the vertical shear difference Δ″ is smaller than/equal to the predefined vertical shear tolerance value T″ the required tool 14 is not subject to abrasion and will be continued to use, and with a vertical shear difference Δ″ that is greater than the predefined vertical shear tolerance value T″ the required tool (14) is subject to abrasion and will be replaced. As a first approximation, the predefined vertical shear tolerance value T″ is equal to 10% of the vertical shear reference signals R″.

αᵢ″*Sd₁″−R″=Δ″≤T″=10%*R″

For each process step, the computer 16.2 calculates a horizontal force difference Δ′″ of the calibrated digital horizontal force measurement signals Sd₁′″ and the loaded horizontal force reference signal R″ for the material of the workpiece 9 and the cutting material of the required tool 14. In the case when the horizontal force difference Δ″ is smaller than/equal to the predefined horizontal force tolerance value T′″ the required tool 14 is not subject to abrasion and will be continued to use, and with a horizontal force difference Δ′″ that is greater than the predefined horizontal force tolerance value T′″ the required tool (14) is subject to abrasion and will be replaced. As a first approximation, the predefined horizontal force tolerance value T′″ is equal to 10% of the horizontal force reference signals R′″.

αᵢ′″*Sd₁−R′″=Δ′″≤T′″=10%*R′″

Analogously, when two force transducers are used such as in the second embodiment of the cutting machine according to FIG. 2, the two force transducers generate first and second analog measurement signals and these first and second analog measurement signals are converted into first and second digital measurement signals by the converter unit. The computer calculates a sum of the first and second digital measurement signals for each required tool and multiplies this sum of first and second digital measurement signals by a calibration factor for a position of the required tool, and subtracts from this calibrated sum of first and second digital measurement signals a reference signal of a pair of materials of the workpiece and the cutting material of the required tool.

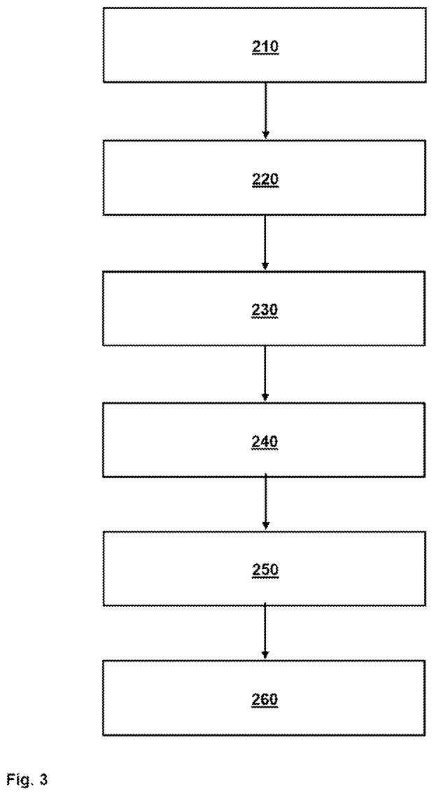

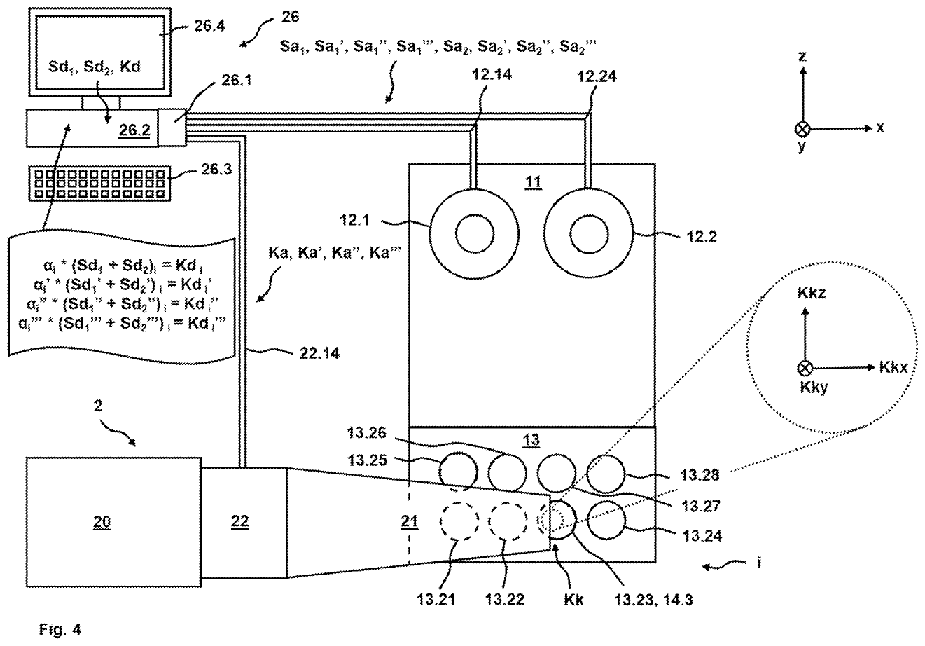

FIG. 3 shows a flow chart illustrating the process steps 210-260 for the calibration of the at least one force transducer 12.1, 12.2 of the cutting machine 1 of the two embodiments according to FIG. 1 or 2. FIG. 4 shows portions of an embodiment of a calibration device 2 for carrying out the process steps according to FIG. 3 with the second embodiment of the cutting machine 1 according to FIG. 2.

The calibration device 2 comprises a calibration contact 21, a calibration force transducer 21, a calibration drive unit 20 and an evaluation unit 26.

In a first process step 210 is provided a machine tool arm 11 with a required tool 14 and with at least one force transducer 12.1, 12.2.

In a further process step 220, the force transducer 12.1, 12.2 is contacted with the evaluation unit 26. Evaluation unit 26 comprises at least one converter unit 26.1, at least one computer 26.2, at least one input unit 26.3 and at least one output unit 26.4.

In the embodiment of the calibration device 2 according to FIG. 4, two force transducers 12.1, 12.2 are electrically connected to the converter unit 26.2 via signal cables 12.14, 12.24.

In a further process step 230, the calibration device 2 applies a calibration force Kk to a required tool 14.

Calibration device 2 comprises a calibration drive unit 20, a calibration contact 21, and a calibration force transducer 22.

The calibration drive unit 20 is an electrical drive unit, a pneumatic drive unit, etc. The calibration drive unit 20 moves the calibration contact 21 and the calibration force transducer 22 along three axes, x, y, and z. The calibration drive unit 20 aligns the calibration contact 21 precisely with required tools 14 in positions i within the tool holder 13 and applies the calibration force Kk to the required tool 14. The calibration force Kk comprises three calibration force components, Kkx, Kky, Kkz. The calibration force Kk comprises a transverse shear calibration component Kkx in the direction of the transverse axis x, a vertical shear calibration component Kkz in the direction of the vertical axis y and a horizontal force calibration component Kkz in the direction of the horizontal axis z.

In the embodiment of the calibration device 2 according to FIG. 4, the calibration contact 22 is shaped like a finger and comprises a tip for exerting the calibration force Kk. The calibration contact 22 is made of mechanically resistant material such as steel, tool steel, etc. The calibration contact 22 is made of a material having a high modulus of elasticity of more than 200 GPa. Due to its high modulus of elasticity, the calibration contact 22 transmits the calibration force Kk more inelastically than a calibration contact made of a material having a lower modulus of elasticity.

The calibration force transducer 22 measures three calibration force components, Kkx, Kky, Kkz, of the calibration force Kk. The calibration force transducer 22 may function according to any measuring principle. However, a prerequisite for performing the calibration is that the calibration force transducer 22 measures the calibration force components, Kkx, Kky, Kkz, of the calibration force Kk with an accuracy that is at least one order of magnitude greater than that of the at least one force transducer 12.1 12.2. The calibration force transducer 22 is electrically connected to the converter unit 26.2 via a calibration signal cable 22.14.

In a further process step 240, the calibration force components, Kkx, Kky, Kkz, are measured by the force transducer 12.1, 12.2 and by the calibration force transducer 22 of the calibration device 2.

The first force transducer 12.1 generates first analog measurement signals Sa₁. Said first analog measurement signals Sa₁ include first analog transverse shear signals Sa₁′ for a transverse shear calibration component Kkx in the direction of the transverse axis x, first analog vertical shear signals Sa₁″ for a vertical shear calibration component Kkz in the direction of the vertical axis z and first analog horizontal force signals Sa₁″ fora horizontal force calibration component Kky in the direction of the horizontal axis y.

The second force transducer 12.2 generates second analog measurement signals Sa₂. The second analog measurement signals Sa₂ include second analog transverse shear signals Sa₂′ for a transverse shear calibration component Kkx in the direction of the transverse axis x, second analog vertical shear signals Sa₂″ for a vertical shear calibration component Kkz in the direction of the vertical axis z and second analog horizontal force signals Sa₂″ for a horizontal force calibration component Kky in the direction of the horizontal axis y.

The calibration force transducer 22 generates analog calibration signals Ka. The calibration signals Ka include analog transverse shear calibration signals Ka′ for a transverse shear calibration component Kkx in the direction of the transverse axis x, analog vertical shear calibration signals Ka″ for a vertical shear calibration component Kkz in the direction of the vertical axis z and analog horizontal force calibration signals Ka′″ for a horizontal force calibration component Kky in the direction of the horizontal axis y.

In a further process step 250, the measurement signals Sa of the force transducer 12.1, 12.2 and the calibration signals Ka of the calibration force transducer 22 are transmitted to the evaluation unit 26.

In the embodiment of the calibration device 2 according to FIG. 4, analog measurement signals Sa₁, Sa₂ transmitted from the signal electrodes via the signal cables 12.14, 12.24 of the two force transducers 12.1, 12.2 are converted in digital measurement signals Sd₁, Sd₂ by the converter unit 26.1.

Converter unit 26.1 converts first analog transverse shear signals Sa₁′ in first digital transverse shear signals Sd₁′, it converts first analog vertical shear signals Sa₁″ in first digital vertical shear signals Sd₁″ and it converts first analog horizontal force signals Sa₁″ in first digital horizontal force signals Sd₁″. The first digital measurement signals Sd₁ include the first digital transverse shear signals Sd₁′, the first digital vertical shear signals Sd₁″ and the first digital horizontal force signals Sd₁″.

Converter unit 26.1 converts second analog transverse shear signals Sa₂′ in second digital transverse shear signals Sd₂′, it converts second analog vertical shear signals Sa₂″ in second digital vertical shear signals Sd₂″ and it converts second analog horizontal shear signals Sa₂″ in second digital horizontal shear signals Sd₂″. The second digital measurement signals Sd₂ include the second digital transverse shear signals Sd₂′, the second digital vertical shear signals Sd₂″ and the second digital horizontal force signals Sd₂″.

Analog calibration signals Ka transmitted from the calibration force transducer 22 via the signal cable 22.14 are converted in digital calibration signals Kd by the converter unit 26.1.

Converter unit 26.1 converts analog transverse shear calibration signals Ka′ in digital transverse shear calibration signals Sd′, it converts analog vertical shear calibration signals Ka″ in digital vertical shear calibration signals Kd″ and it converts analog horizontal force calibration signals Ka′″ in digital horizontal force calibration signals Kd′″. The digital calibration signals Kd include the digital transverse shear calibration signals Kd′, the digital vertical shear calibration signals Kd″ and the digital horizontal force calibration signals Kd′″.

In a further process step 260, the transmitted measurement signals Sa₁ and the transmitted calibration signals Ka are compared in the evaluation unit 26.

The computer 26.2 comprises at least one data processor and at least one data memory. Computer 26.2 may be operated by the input unit 26.3. The input unit 26.3 may be a keyboard, for inputting control commands. In the context of the present invention, the verb “operate” means that the computer 26.2 is started, controlled and switched off by control commands input by a user via the input unit 26.3. The computer 26.2 loads the digital measurement signals Sd₁, Sd₂ with the digital calibration signals Kd. The computer 26.2 displays compared digital measurement signals Sd₁, Sd₂ and digital calibration signals Kd on the output unit 26.4. The output unit 26.4 may be a display screen, for graphically representing the evaluated digital measurement signals.

The computer 26.2 compares digital measurement signals Sd₁, Sd₂ to digital calibration signals Kd. This comparison is specific for a position i of a required tool 14. The calibration contact 22 applies a calibration force Kk to a third required tool 14.3 accommodated in a third recess 13.23. The third recess 13.23 is the third position i=3 and the required tool 14.3 is located in the third position i=3.

For the comparison as performed by the embodiment of the calibration device 2 according to FIG. 4, computer 26.2 calculates a position-specific sum (Sd₁+Sd₂)ᵢ of the first and second digital measurement signals Sd₁, Sd₂ which it compares in a position-specific manner to the digital calibration signal Kdᵢ. A result of this comparison is a position-specific calibration factor αᵢ.

αᵢ*(Sd₁+Sd₂)ᵢ=Kdᵢ i=1 . . . 8

When the position-specific sum (Sd₁+Sd₂)ᵢ is identical to the digital calibration signal Kdᵢ, the position-specific calibration factor αᵢ=1.00. Typically, the position-specific calibration factor αᵢ varies in a range from 0.85 to 1.15.

Analogously, when a single force transducer is used as in the first embodiment of the cutting machine according to FIG. 1, said force transducer generates analog measurement signals that are converted in digital measurement signals by the converter unit. On a position-specific basis, the computer compares the digital measurement signals with digital calibration signals. In the case where only one force transducer is used, digital measurement signals are available only from this force transducer so that no position-specific sum of digital measurement signals of two force transducers is calculated.

For performing the comparison, computer 26.2 calculates a position-specific sum (Sd₁′+Sd₂′)ᵢ of the digital transverse shear signals Sd₁′, Sd₂′ which it compares to the position-specific digital transverse shear calibration signal Kdᵢ′. A result of this comparison is a transverse shear calibration factor αᵢ′.

αᵢ′*(Sd₁′+Sd₂′)ᵢ=Kdᵢ′ i=1 . . . 8

For performing the comparison, computer 26.2 calculates a position-specific sum (Sd₁″+Sd₂″)ᵢ of the digital vertical shear signals Sd₁″, Sd₂″ which it compares to the position-specific digital vertical shear calibration signal Kdᵢ“. A result of this comparison is a vertical shear calibration factor αᵢ”.

αᵢ″*(Sd₁″+Sd₂″)ᵢ=Kdᵢ″i=1 . . . 8

For performing the comparison, computer 26.2 calculates a position-specific sum (Sd₁′″+Sd₁″), of the digital horizontal force signals Sd₁′″, Sd₂′″ which it compares to the position-specific digital horizontal force calibration signal Kdᵢ′″. A result of this comparison is a horizontal force calibration factor αᵢ′″.

αᵢ′″*(Sd₁′″+Sd₂′″)ᵢ=Kdᵢ′″ i=1 . . . 8

The calibration factor αᵢ may be stored in the data memory of the computer 16 of the evaluation unit 16. In addition, each transverse shear calibration factor αᵢ′, each vertical shear calibration factor αᵢ″ and each horizontal force calibration factor αᵢ″ may be stored in the data memory of the computer 16 of the evaluation unit 16.

### LIST OF REFERENCE NUMERALS

1 screw
2 breakaway screw
3 cylindrical portion
4 threaded portion
5 mating element
6 threaded nut
7 cylindrical portion
8 shear-off portion
9 head portion
10 screw load testing device
12 housing
14 first housing member
16 size change member
17 end face
18 through-hole
19 first contact surface
20 longitudinal groove
22 longitudinal axis
24 clamping device
26 first member of clamping device
27 through-bore
28 second member of clamping device
30 hydraulic connection portion
34 hydraulic element
36 vent connection element
38 pressure chamber
39 abutment surface
40 abutment surface
41 arrow
42 sealing element
43 sealing element
44 blind hole
45 spring element
46 resetting means
48 support plate
49 screw
51 through-bore
52 recess
54 further housing member
56 bore portion
58 annular washer
59 radial gap
60 sleeve-shaped insert
61 second contact surface
62 second housing member
63 dowel pin
64 end face
65 further washer
66 surface
67 surface
70 measuring device
72 plug connection
74 torque measuring body
76 axial gap
a₁ first distance
a₂ second distance

1. A cutting machine for chip-removing machining of a workpiece during a sequence of manufacturing steps by using a plurality of required tools, the cutting machine comprising:
a tool holder configured for holding the required tools;
a drive unit;
a tool arm connecting said tool holder with the drive unit;
wherein the drive unit is configured to move the tool arm so that one of the required tools becomes aligned to operate on the workpiece in each manufacturing step;
wherein the tool arm includes an upper arm secured to the drive unit;
wherein the tool arm includes a lower arm secured to the tool holder and mechanically connected to the upper arm;
a force transducer disposed between the upper arm and the lower arm and configured for measuring the force exerted on the workpiece by any of the tools held by the tool holder during chip-removing machining of the workpiece.

2. The cutting machine according to claim 1, wherein the upper arm and lower arm are mechanically connected to one another by a connecting means that mechanically preloads the force transducer.

3. The cutting machine according to claim 1, wherein the tool holder is made of a material having a high modulus of elasticity of more than 200 GPa.

4. The cutting machine according to claim 1, wherein the tool arm is made of a material having a high modulus of elasticity of more than 200 GPa.

5. A tool arm for use in a cutting machine for chip-removing machining of a workpiece, said chip-removing machining being performed in a chronological sequence of manufacturing steps by using a plurality of required tools and including a tool holder for holding the required tools; wherein the tool arm is configured for connecting the tool holder with a drive unit that is configured for moving the tool arm so that one of the required tools can be aligned with the workpiece in each manufacturing step, wherein the tool arm comprises:
an upper arm configured to be connected to the drive unit;
a lower arm mechanically connected to the upper arm and configured to be connected with the tool holder; and
a force transducer disposed between the upper arm and the lower arm in a path of the transmission of a tool force from the workpiece through the tool during chip-removing machining of the workpiece.

6. A process for operating a cutting machine for chip-removing machining of a workpiece by any one of a plurality of required tools, wherein the cutting machine includes a tool holder configured for holding the required tool, a drive unit, a tool arm connecting the tool holder with the drive unit and including an upper arm secured to the drive unit, a lower arm secured to the tool holder and mechanically connected to the upper arm, and a force transducer disposed between the upper arm and the lower arm, the process including the following steps:
using the tool holder to hold the required tool;
using the drive unit to move the arm so that the required tool held in the tool holder is aligned with the workpiece;
using the required tool in performing chip-removing machining of the workpiece;
using the force transducer to measure a tool force exerted by the required tool during chip-removing machining of the workpiece.

7. The process according to claim 6, wherein during chip-removing machining of the workpiece the required tool performs a cutting movement in the transverse plane defined by a transverse axis and a vertical axis so that the tool force comprises a transverse shear component in the direction of the transverse axis and a vertical shear component in the direction of the vertical axis; wherein during chip-removing machining of the workpiece the required tool performs an advancing movement in the direction of a horizontal axis so that the tool force comprises a horizontal force component in the direction of the horizontal axis; and wherein for each tool force measured in a manufacturing step the force transducer generates analog measurement signals.

8. The process according to claim 7, wherein said analog measurement signals measured by the force transducer include analog transverse shear signals for the transverse shear component in the direction of the transverse axis, analog vertical shear signals for a vertical shear component in the direction of the vertical axis and analog horizontal force signals for a horizontal force component in the direction of the horizontal axis.

9. The process according to claim 7, wherein the cutting machine includes a converter unit and wherein for each chip-removing machining step performed with a required tool said converter unit converts analog measurement signals into digital measurement signals.

10. The process according to claim 9, wherein the cutting machine includes a computer and wherein for each chip-removing machining step said computer loads the digital measurement signals; wherein said computer stores a reference signal for a material of the workpiece and for a cutting material of a required tool, which reference signal is loaded for each chip-removing machining step; wherein said computer stores a specific calibration factor for a position of the required tool relative to the force transducer, which calibration factor is loaded for each chip-removing machining step; wherein digital measurement signals loaded for each chip-removing machining step are calibrated by multiplying them with the loaded calibration factor; and wherein for each chip-removing machining step a difference between the calibrated digital measurement signals and the loaded reference signal is calculated.

11. The process according to claim 10, wherein said computer stores a predefined tolerance value, which predefined tolerance value is loaded for each chip-removing machining step; wherein for each chip-removing machining step the difference is compared to the predefined tolerance value; and when the difference is smaller than or equal to the predefined tolerance value, then the required tool (14) is not deemed subject to abrasion and remains in use; and with a difference that is greater than the predefined tolerance value, then the required tool (14) is deemed subject to abrasion and is replaced.

12. The process according to claim 7, wherein the force transducer includes a first piezoelectric element that is oriented to generate electrical polarization charges with maximum sensitivity to the transverse shear component; wherein the force transducer includes a second piezoelectric element that is oriented to generate electrical polarization charges with maximum sensitivity to the vertical shear component; and wherein the force transducer includes a third piezoelectric element that is oriented to generate electrical polarization charges with maximum sensitivity to the horizontal force component.

13. A process for using a calibration force transducer for calibrating a force transducer of a cutting machine for chip-removing machining of a workpiece by any one of a plurality of required tools, wherein the cutting machine includes a tool holder configured for holding a required tool, a drive unit, a tool arm connecting the tool holder with the drive unit and including an upper arm secured to the drive unit, a lower arm secured to the tool holder and mechanically connected to the upper arm, and a force transducer disposed between the upper arm and the lower arm, the process including the following steps:
disposing the required tool in a position relative to the force transducer;
applying a calibration force to the required tool;
measuring the calibration force with the force transducer and generating analog measurement signals for the measured calibration force;
measuring the calibration force with the calibration force transducer and generating analog calibration signals for the measured calibration force;
wherein the analog measurement signals (Sa₁, Sa₂) are converted into digital measurement signals;
wherein the analog calibration signals are converted into digital calibration signals; and
a comparison of digital measurement signals and digital calibration signals is carried out, wherein a result of said comparison is a calibration factor that is specific for the position of the required tool relative to the force transducer.

14. The cutting machine according to claim 1, further comprising:
a converter unit configured to convert analog signals to digital signals; and
a signal cable electrically connecting the converter unit to the force transducer.

15. The cutting machine according to claim 14, further comprising:
a computer electrically connected to the converter unit and including a data processor and a data memory; and
an input unit electrically connected to the computer; and
an output unit electrically connected to the computer.
